(19) United States
(12) Patent Application Publication
(10) Pub. No.: US 2012/0178393 A1
(43) Pub. Date: Jul. 12, 2012

(54) RECEIVING APPARATUS AND INTERFERENCE POWER ESTIMATION METHOD

(75) Inventors: Hiroyuki Kawai, Tokyo (JP); Mototsugu Suzuki, Tokyo (JP); Tetsuro Imai, Tokyo (JP); Yoshihiro Ishikawa, Tokyo (JP)

(73) Assignee: NTT DOCOMO, INC., Tokyo (JP)

(21) Appl. No.: 13/391,697

(22) PCT Filed: Aug. 12, 2010
(86) PCT No.: PCT/JP2010/063682

§ 371 Date: Mar. 14, 2012

(30) Foreign Application Priority Data
Aug. 24, 2009 (JP) 2009-193534

(51) Int. Cl. H04B 17/00

(52) U.S. Cl. 455/226.1

(57) ABSTRACT

Provided are a receiving apparatus and an interference power estimation method that can perform interference power estimation with high accuracy even when correlation in a fading variation between reference signals is low and obtain accurate receiving quality. The interference power estimation method according to the present invention receives a plurality of discontinuous reference signals on the time/frequency plane, extracts the reference signals from the received signal, linear-combines channel variation values obtained from reference signals surrounding a reference signal of a specific time/frequency on the time/frequency plane with predetermined weighting and estimates interference power using the linear-combined value resulting from the linear combining.

### TECHNICAL FIELD

The present invention relates to a receiving apparatus and an interference power estimation method in a mobile communication system.

### BACKGROUND ART

In mobile communication systems, it is important to accurately measure receiving quality, such as an SIR (Signal-to-Interference power Ratio), of a downlink in a service area from various downlink control channels. An LTE (Long Term Evolution)-based mobile communication system uses reference signals (RS) discontinuously mapped on the time and frequency axes as shown in FIG. 1 to measure the SIR. To be more specific, using channel variation amounts r₁ and r_{c} calculated from reference signals of a received signal shown in FIG. 1, interference power is estimated by multiplying E(|r₁−r_{c}|²) (E: ensemble average) by ½ and an SIR is calculated using this interference power estimate value.

### CITATION LIST

### Non-Patent Literature

Non-Patent Literature 1: Institute of Electronics, Information and Communication Engineers, Society Conference B-1-24 in 2008

### SUMMARY OF INVENTION

### Technical Problem

The above-described interference power estimation method can perform interference power estimation with accuracy when a channel variation between channel variation values r₁ and r_{c} (within a solid frame in FIG. 1) calculated from two reference signals respectively is small, that is, when the reference signals are sufficiently close to each other on the time and frequency axes compared to the period of a variation of instantaneous fading and influences of the variation of instantaneous fading are limited. However, when the moving speed is high or a delay spread is large, the correlation in the fading variation between the channel variation values r₁ and r_{c} calculated from the two reference signals is low and there are influences of a variation of instantaneous fading between r₁ and r_{c}. In this case, the accuracy of interference power estimation using the above-described interference power estimation method deteriorates considerably. This results in a problem that the SIR, which is receiving quality, cannot be measured accurately.

The present invention has been implemented in view of the above-described problems and it is an object of the present invention to provide a receiving apparatus and an interference power estimation method capable of performing interference power estimation with high accuracy even when correlation in a fading variation between reference signals is low and obtaining accurate receiving quality.

### Solution to Problem

A receiving apparatus according to the present invention includes reference signal extracting section configured to extract, from a received signal including a plurality of discontinuous reference signals on a time/frequency plane, the reference signals and calculating a channel variation value, linear combining section configured to linear-combine channel variation values obtained from reference signals surrounding a reference signal of a specific time/frequency on the time/frequency plane with predetermined weighting and interference power estimating section configured to estimate interference power using a linear-combined value resulting from the linear combining.

According to this configuration, it is possible to interpolate a fading variation in a region defined by reference signals surrounding a reference signal of a specific time/frequency on the time/frequency plane. As a result, it is possible to perform interference power estimation with high accuracy even when correlation in a fading variation between reference signals is low and consequently obtain accurate receiving quality.

In the receiving apparatus of the present invention, the interference power estimating section preferably obtains an estimate value of interference power by calculating the square and average of a difference between the linear-combined value and the channel variation value obtained from the reference signal of a specific time/frequency.

In the receiving apparatus of the present invention, the reference signals on the time/frequency plane are preferably mapped to an arrangement used in an LTE system.

In the receiving apparatus of the present invention, when it is assumed that a channel variation value calculated from reference signal RS_{c} of the specific time/frequency is r_{c}, channel variation values obtained from reference signals RS₁, RS₂, RS₃ and RS₄ surrounding the reference signal are r₁, r₂, r₃ and r₄, the reference signals RS₁ and RS₂ are arranged apart from the reference signal RS_{c} by 3 subcarriers and 4 symbols in frequency and time domain, respectively, the reference signals RS₃ and RS₄ are arranged apart from the reference signal RS_{c} by 3 subcarriers and 3 symbols in frequency and time domain, respectively, it is preferable that linear combining with the predetermined weighting be r_{c}′=(3r₁+3r₂+4r₃+4r₄)/14 and a value obtained by multiplying a value of E(|r_{c}′−r_{c}|²) (E is an ensemble average) by 98/123 be an estimate value of interference power.

An interference power estimation method according to the present invention includes a step of receiving a signal including a plurality of discontinuous reference signals on a time/frequency plane, a step of extracting the reference signals from the signal and obtaining a channel variation value, a step of linear-combining the channel variation values obtained from reference signals surrounding a reference signal of a specific time/frequency on the time/frequency plane with predetermined weighting, and a step of estimating interference power using a linear-combined value resulting from the linear combining.

According to this method, it is possible to interpolate a fading variation in a region defined by reference signals surrounding a reference signal of a specific time/frequency on the time/frequency plane. As a result, it is possible to perform interference power estimation with high accuracy even when correlation in a fading variation between reference signals is low and consequently obtain accurate receiving quality.

In the interference power estimation method according to the present invention, an estimate value of interference power is preferably calculated from the square and average of a difference between the linear-combined value and a channel variation value calculated from the reference signal of a specific time/frequency.

In the interference power estimation method according to the present invention, the reference signals on the time/frequency plane are preferably mapped to an arrangement in an LTE system.

In the interference power estimation method according to the present invention, when it is assumed that a channel variation value calculated from reference signal RS_{c} of the specific time/frequency is r_{c}, channel variation values obtained from reference signals RS₁, RS₂, RS₃ and RS₄ surrounding the reference signal are r₁, r₂, r₃ and r₄, the reference signals RS₁ and RS₂ are arranged apart from the reference signal RS_{c} by 3 subcarriers and 4 symbols in frequency and time domain, respectively, the reference signals RS₃ and RS₄ are arranged apart from the reference signal RS_{c} by 3 subcarriers and 3 symbols in frequency and time domain, respectively, it is preferable that linear combining with the predetermined weighting be r_{c}′=(3r₁+3r₂+4r₃+4r₄)/14 and a value obtained by multiplying a value of E(|r_{c}′−r_{c}|²) (E is an ensemble average) by 98/123 be an estimate value of interference power.

### Technical Advantage of Invention

The present invention receives a signal including a plurality of discontinuous reference signals on the time/frequency plane, extracts the reference signals from the signal, linear-combines the reference signals surrounding a reference signal of a specific time/frequency on the time/frequency plane with predetermined weighting and estimates interference power using the linear-combined value resulting from the linear combining, and can thereby perform interference power estimation with high accuracy even when correlation in a fading variation between reference signals is low and thereby obtain accurate receiving quality.

### BRIEF DESCRIPTION OF DRAWINGS

FIG. 1 is a diagram illustrating a conventional interference power estimation method;

FIG. 2 is a diagram illustrating an interference power estimation method according to the present invention;

FIG. 3 is a diagram illustrating weighting in linear combining according to the present invention;

FIG. 4 is a diagram illustrating an arrangement example of reference signals;

FIG. 5 is a diagram illustrating an arrangement example of reference signals;

FIG. 6 is a diagram illustrating a schematic configuration of a receiving apparatus according to the present invention;

FIG. 7 is a diagram illustrating an SIR measurement error characteristic versus a delay spread; and

FIG. 8 is a diagram illustrating an SIR measurement error characteristic versus a moving speed.

### DESCRIPTION OF EMBODIMENTS

Hereinafter, an embodiment of the present invention will be described in detail with reference to the accompanying drawings. The present embodiment will describe a method of measuring downlink receiving quality (SIR) in an LTE system using OFDM (Orthogonal Frequency Divisional Multiplex).

The interference power estimation method according to the present invention receives a signal including a plurality of discontinuous reference signals on a time/frequency plane, extracts the reference signals from the signal, linear-combines the reference signals surrounding a reference signal of a specific time/frequency on the time/frequency plane with predetermined weighting and estimates interference power using the linear-combined value resulting from the linear combining.

Thus, by linear-combining reference signals surrounding a reference signal of a specific time/frequency on the time/frequency plane with predetermined weighting, it is possible to interpolate a fading variation in a region defined by reference signals surrounding the reference signal of a specific time/frequency on the time/frequency plane. As a result, even when correlation in a fading variation between reference signals is low, it is possible to perform interference power estimation with high accuracy.

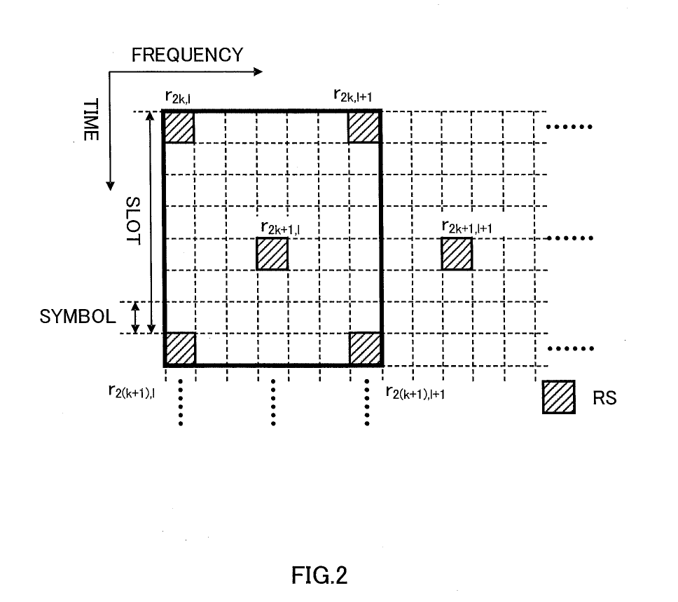

FIG. 2 is a diagram illustrating an arrangement of RSs on a downlink used in an LTE system. As shown in FIG. 2, RSs are arranged on a first symbol and fifth symbol of each slot, every six subcarriers on the time/frequency plane. In this RS arrangement, the RS on the fifth symbol is arranged in a region defined by four RSs; two RSs on the first symbol in a certain slot and a slot adjacent thereto and two RSs adjacent in the frequency direction of these two RSs (region enclosed by a thick line in FIG. 2). In other words, in this RS arrangement, RSs on the first symbol are arranged in a region defined by four RSs; two RSs on a fifth symbol in a certain slot and a slot adjacent thereto and two RSs adjacent in the frequency direction of these two RSs. In this way, in the RS arrangement shown in FIG. 2, the region made up of four neighboring RSs on the first symbols of their respective slots and the region made up of neighboring four RSs on the fifth symbols of their respective slots overlap each other.

The present invention estimates interference power using a channel variation value r_{2k+1,l} calculated from the received signal of the RS on the fifth symbol of the slot shown in FIG. 2 and channel variation values r_{2k,l}, r_{2k,l+1}, r_{2(k+1),l} and r_{2(k+1),l+1} calculated from the received signals of the four RSs on the first symbols of the slots surrounding the RS as one unit and by interpolating a fading variation and calculating a variance of the received signal. Furthermore, the present invention performs averaging in the frequency and time directions using an estimate value P_{I} of the interference power and average power P_{S} of the received signal obtained in this way, and thereby calculates an average SIR (=P_{S}/P_{I}).

The present invention performs processing of interpolating a fading variation in the region made up of four neighboring RSs on the first symbols or fifth symbols of the slots. That is, the present invention linear-combines channel variation values obtained from received signals of RSs surrounding an RS of a specific time/frequency on the time/frequency plane with predetermined weighting, subtracts a channel variation value calculated from the received signal of the RS of the specific time/frequency from the linear-combined value resulting from the linear combining, averages the subtraction value after the subtraction and assumes the average value after the averaging as an estimate value of the interference power. Furthermore, the present invention measures an SIR using the estimate value of this interference power.

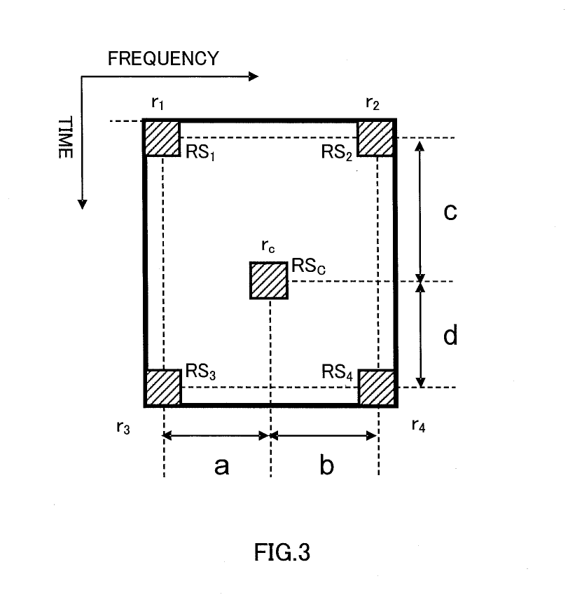

Here, a description will be given of weighting when the RSs (four neighboring RSs) surrounding the RS of the specific time/frequency are linear-combined with predetermined weighting. FIG. 3 is a diagram for illustrating weighting when performing linear combining according to the present invention.

In FIG. 3, it is assumed that a channel variation value calculated from a reference signal RS_{c} of a specific time/frequency is r_{c} and channel variation values calculated from four RSs surrounding the reference signal RS_{c}; RS₁, RS₂, RS₃ and RS₄ are r₁, r₂, r₃ and r₄. The reference signal RS₁ is arranged by a subcarriers, c symbols apart from the reference signal RS_{c}, the reference signal RS₂ is arranged by b subcarriers, c symbols apart from the reference signal RS_{c}, the reference signal RS₃ is arranged by a subcarriers, d symbols apart from the reference signal RS_{c} and the reference signal RS₄ is arranged by b subcarriers, d symbols apart from the reference signal RS_{c}.

Therefore, an interpolated channel variation value r_{c}′ weighted according to the distances from the reference signals RS₁, RS₂, RS₃ and RS₄ with respect to the reference signal RS_{c} is expressed by equation (1) below.

r_{c}′=(bd·r₁+ad·r₂+bc·r₃+ac·r₄)/{(a+b)(c+d)} Equation (1)

Then, interference power is estimated using this interpolated channel variation value r_{c}′. That is, a value resulting from normalizing a variance of the interpolated channel variation value r_{c}′ and the channel variation value r_{c} calculated from the RS_{c} is assumed to be an estimate value of the interference power (equation (2) below).

E(|r_{c}′−r_{c}|²)/X

X=1+[(a²+b²)(c²+d²){(a+b)(c+d)}²] Equation (2)

Here, assuming that a reference signal of a specific time/frequency is a reference signal r_{c}, reference signals surrounding the reference signal r_{c} are reference signals r₁, r₂, r₃ and r₄, the reference signals RS₁ and RS₂ are arranged by 3 subcarriers, 4 symbols apart from the reference signal RS_{c} and the reference signals RS₃ and RS₄ are arranged by 3 subcarriers, 3 symbols apart from the reference signal RS_{c}, that is, when a=b=3, c=4, d=3 are substituted into equation (1) and equation (2) above, the interpolated reference channel variation value r_{c}′ and X are expressed as shown below.

r_{c}′=(3r₁+3r₂+4r₃+4r₄)/14

X=123/98

Therefore, assuming r_{c}′=(3r₁+3r₂+4r₃+4r₄)/14, the estimate value of the interference power is a value obtained by multiplying the value of E(|r_{c}′−r_{c}|²) (E is an ensemble average) by 98/123.

Furthermore, as described above, using the reference signals RS₁, RS₂, RS₃ and RS₄ surrounding the reference signal RS_{c} as one unit, the channel variation is interpolated, average power and a variance of the received reference signal are calculated and then averaged in the frequency and time directions as shown in equation (3) below to thereby calculate an average SIR (=P_{S}/P_{I}).

$${P}_{I} = \frac{98}{123} {\sum }_{k = 0}^{{N}_{K} / 2 - 2} {\sum }_{l = 0}^{{N}_{L} - 2} {\vert \frac{3 ( \begin{matrix}{r}_{2 k , l} + \\ {r}_{2 k , l + 1}\end{matrix} ) + 4 ( \begin{matrix}{r}_{2 ( k + 1 ) , l} + \\ {r}_{2 ( k + 1 ) l + 1}\end{matrix} )}{14} - {r}_{2 k + 1 , l} \vert}^{2} / ( \frac{{N}_{k}}{2} - 1 ) ( {N}_{L} - 1 ) \\ {P}_{S} = ( {\sum }_{k = 0}^{{N}_{K} - 1} {\sum }_{l = 0}^{{N}_{L} - 1} {\vert {r}_{k , l} \vert}^{2} / {N}_{K} {N}_{L} ) - {P}_{I} \qquad [ Equation 1 ]$$

where, N_{L} and N_{K} are the number of RSs in the averaging sections in the frequency direction and time directions respectively.

Thus, the above described interference power estimation method interpolates a fading variation in a region defined by reference signals surrounding a reference signal of a specific time/frequency on the time/frequency plane, and can consequently perform interference power estimation with high accuracy even when correlation in a fading variation between reference signals is low, and can thereby obtain accurate receiving quality.

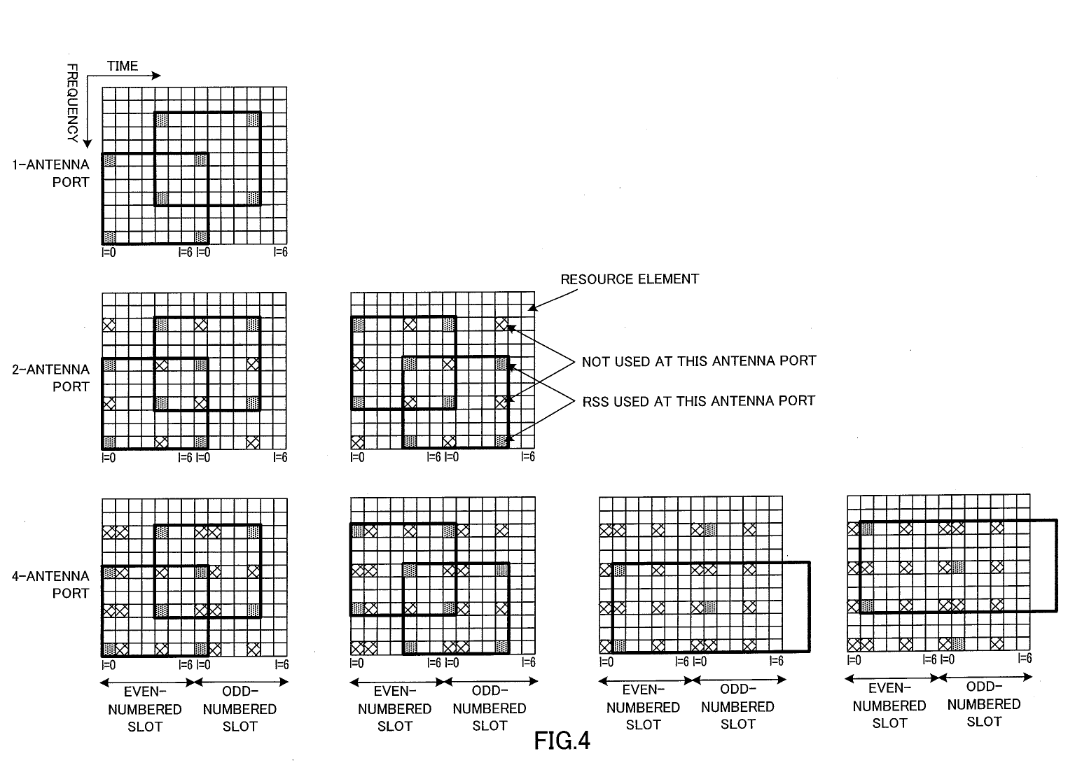

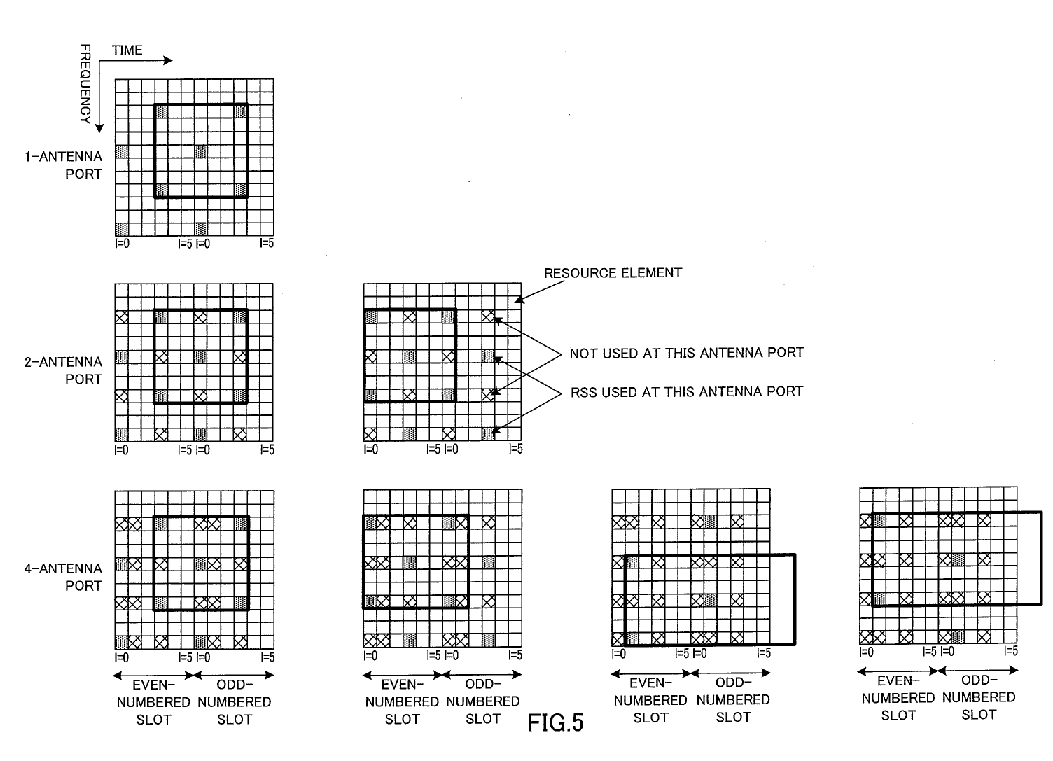

In the interference power estimation method according to the present invention, an example of the region (interpolation region, interpolation unit) defined by RSs surrounding an RS of a specific time/frequency on the time/frequency plane is an RS arrangement region used in an LTE system. That is, in an RS arrangement region as shown in FIG. 4 and FIG. 5, regions enclosed by thick lines are interpolation regions or interpolation units.

To be more specific, in the case of a normal CP (Normal Cyclic Prefix) length, the RS arrangement is as shown in FIG. 4. The RS arrangement configuration (the number of symbols and positions) shown in FIG. 4 is determined from the standpoint of channel estimation accuracy and overhead, and when the number of antennas is 1 or 2 (1-antenna port, 2-antenna port), RSs are mapped on the first symbol and fifth symbol in each slot and every six subcarriers for each antenna, as shown in FIG. 2. When the number of antennas is 4 (4-antenna port), RSs corresponding to the third and fourth antennas are mapped only on the second symbol to the same subcarriers as those of the first and second antennas. Furthermore, in the case of a long CP (Long Cyclic Prefix) length, the RS arrangement is as shown in FIG. 5. When the number of antennas is 1 or 2 (1-antenna port, 2-antenna port), RSs are mapped onto the first symbol and fourth symbol in each slot every six subcarriers for each antenna, as shown in FIG. 2. When the number of antennas is 4 (4-antenna port), RSs corresponding to the third and fourth antennas are mapped only on the second symbol in the slot to the same subcarriers as those of the first and second antennas.

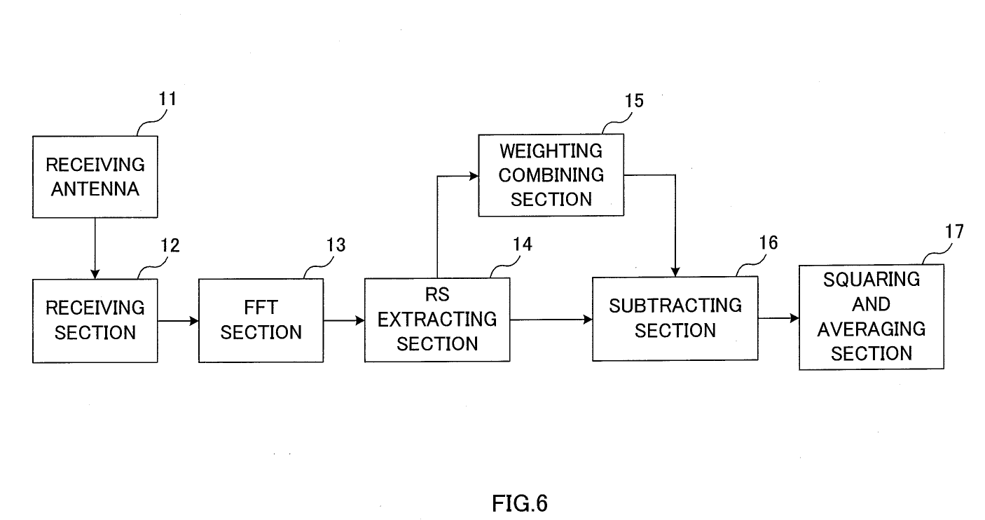

FIG. 6 is a diagram illustrating a schematic configuration of the receiving apparatus according to the present invention. Here, a case of a receiving apparatus in a mobile terminal apparatus in an LTE system will be described. The receiving apparatus shown in FIG. 6 mainly comprises a receiving antenna 11, a receiving section 12, an FFT (Fast Fourier Transform) section 13, an RS extracting section 14, a weighting combining section 15, a subtracting section 16 and a squaring and averaging section 17. Furthermore, the mobile terminal apparatus is also provided with a transmitting section, which will however be omitted for simplicity of explanation.

The receiving section 12 receives an OFDM signal from the radio base station apparatus via the receiving antenna 11. The receiving section 12 outputs the OFDM signal to the FFT section 13. The FFT section 13 applies FFT to the OFDM signal to transform the signal into a frequency-domain signal. The FFT section 13 outputs the signal after the FFT to the RS extracting section 14.

The RS extracting section 14 extracts RSs from the signal after the FFT. For example, the RS extracting section 14 extracts received signals corresponding to reference signals RS_{c}, RS₁, RS₂, RS₃ and RS₄ in FIG. 3 and calculates their respective channel variation values r_{c}, r₁, r₂, r₃ and r₄. The channel variation values r₁, r₂, r₃ and r₄ used for weighting combining are outputted to the weighting combining section 15 and the channel variation value r_{c} is outputted to the subtracting section 16.

The weighting combining section 15 calculates an interpolation channel variation value r_{c}′ using the channel variation values r₁, r₂, r₃ and r₄ from equation (1). In this case, since information on the number of antennas is already broadcast or reported from the radio base station apparatus, the RS arrangement shown in FIG. 4 or FIG. 5 is known to the mobile terminal apparatus. For this reason, a, b, c and d in FIG. 3 are also known to the mobile terminal apparatus side based on the RS arrangement. Thus, the weighting combining section 15 can calculate the interpolated reference signal r_{c}′ from equation (1) using the reference signals r₁, r₂, r₃, r₄ and a, b, c and d. The weighting combining section 15 outputs the interpolation channel variation value r_{c}′ to the subtracting section 16.

The subtracting section 16 calculates a difference (|r_{c}′−r_{c}|) between the channel variation value r_{c} calculated from the reference signal extracted by the RS extracting section 14 and the interpolation channel variation value r_{c}′ obtained by the weighting combining section 15. The subtracting section 16 outputs the calculated difference to the squaring and averaging section 17. The squaring and averaging section 17 calculates an estimate value of interference power using the difference calculated by the subtracting section 16. That is, the squaring and averaging section 17 calculates the estimate value of interference power according to equation (2). Since a, b, c and d in FIG. 3 are also known to the mobile terminal apparatus side in this case, too, the squaring and averaging section 17 can calculate an estimate value of interference power from equation (2) using the difference, and a, b, c and d.

Thus, it is possible to calculate the average SIR according to equation (3) above using the estimate value of interference power obtained in this way. Since interference power is estimated accurately using the interference power estimation method according to the present invention without influences from a fading variation, this SIR is consequently highly accurate.

Next, the accuracy of SIR measurement was evaluated using a computer simulation to make clear the effects of the present invention. Here, suppose the system bandwidth is 5 MHz, the subcarrier interval is 15 kHz and the number of subcarriers is 300. Furthermore, the transmitting section of the radio base station apparatus time-multiplexes five symbols of pseudo-random data signals and two symbols of RSs, transforms the signals into a time-domain signal through IFFT (Inverse Fast Fourier Transform), and then adds a CP thereto. Furthermore, suppose ideal FFT timing synchronization is used in the receiving section on the mobile terminal apparatus side.

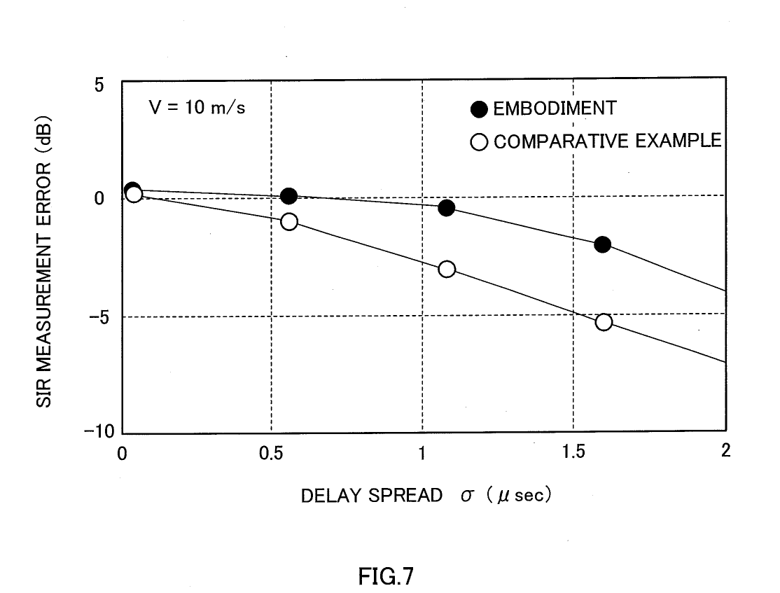

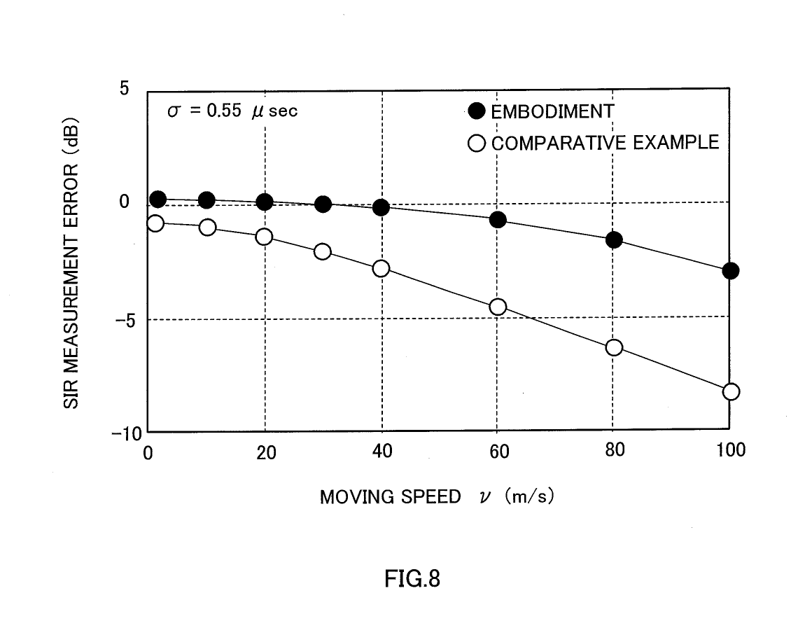

In the present evaluation, suppose the interference power component is white Gaussian noise and the average reception SIR is fixed to 10 dB. Furthermore, as the channel variation, an r.m.s (root mean square) delay spread σ(μsec) and moving speed v (m/s) are assumed as parameters in consideration of an equal level 2-path multipath fading variation. Furthermore, the averaging section is assumed to be an entire transmission signal band in the frequency direction and measurement is performed in the time direction intermittently at an hour rate of 10% while moving 30 meters. The result is shown in FIG. 7 and FIG. 8.

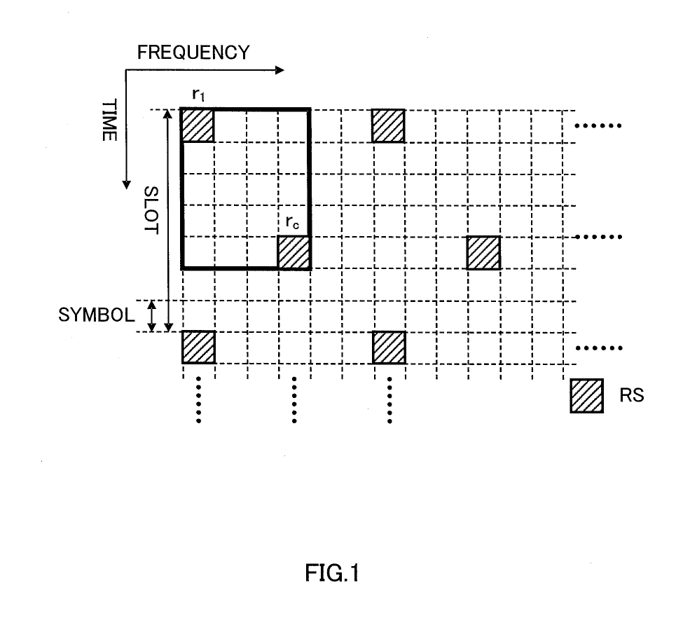

FIG. 7 shows an average SIR measurement error assuming moving speed v=10 (m/s) and delay spread a as parameters. Suppose the SIR measurement error obtained using the interference power estimation method according to the present invention represents the embodiment (black circle) and the SIR measurement error obtained using the conventional method shown in FIG. 1 represents a comparative example (white circle). As is clear from FIG. 7, since no channel variation is taken into consideration in the comparative example, the measurement error increases as the delay spread increases. Compared to this, the embodiment can interpolate the channel variation in the frequency direction and thereby accurately measure interference power, and therefore the measurement error is relatively small.

FIG. 8 shows an average SIR measurement error assuming delay spread σ=0.55 (μsec) and moving speed v as parameters. The SIR measurement error obtained using the interference power estimation method according to the present invention represents the embodiment (black circle) and the SIR measurement error obtained using the conventional method shown in FIG. 1 represents a comparative example (white circle). As is clear from FIG. 8, in the comparative example, it is not possible to remove influences of a channel variation in the time direction when the moving speed increases and the measurement error increases. Compared to this, the embodiment can reduce the average measurement error to within 1 dB when the moving speed≦60 (m/s).

Thus, the present invention performs interference power estimation taking into consideration channel variations among RSs in the frequency direction and the time direction, and can thereby obtain accurate receiving quality (SIR).

The present invention is not limited to the above-described embodiment, but can be implemented modified in various ways. A case has been described in the above-described embodiment where the receiving apparatus is a receiving apparatus of a mobile terminal apparatus assuming a downlink in an LTE system, but the present invention is not limited to this, and the present invention is also applicable to a receiving apparatus of a radio base station apparatus if it is a system that applies OFDM transmission to uplink transmission. Furthermore, a case has been described in the above-described embodiment where RSs in an LTE system are used, but the present invention is not limited to this, and the present invention is applicable irrespective of whether correlation in a fading variation between RSs is high or low.

Furthermore, the present invention can be implemented by modifying the number of processing sections and the processing procedure described above as appropriate without departing from the scope of the present invention. Furthermore, the elements illustrated in the drawings represent their respective functions and each function block may be implemented by hardware or may be implemented by software. The present invention can also be implemented by modifying other aspects of the present invention as appropriate without departing from the scope of the present invention.

The present application is based on Japanese Patent Application No. 2009-193534 filed on Aug. 24, 2009, entire content of which is expressly incorporated by reference herein.

1. A receiving apparatus comprising:
reference signal extracting section configured to extract, from a received signal including a plurality of discontinuous reference signals on a time/frequency plane, the reference signals;
linear combining section configured to linear-combine channel variation values obtained from reference signals surrounding a reference signal of a specific time/frequency on the time/frequency plane with predetermined weighting; and
interference power estimating section configured to estimate interference power using a linear-combined value resulting from the linear combining.

2. The receiving apparatus according to claim 1, wherein the interference power estimating section obtains an estimate value of interference power by calculating the square and average of a difference between the linear-combined value and the channel variation value obtained from the reference signal of a specific time/frequency.

3. The receiving apparatus according to claim 1, wherein the reference signals on the time/frequency plane are mapped to an arrangement used in an LTE system.

4. The receiving apparatus according to claim 1, wherein it is assumed that a channel variation value calculated from reference signal RS_{c} of the specific time/frequency is r_{c}, channel variation values obtained from reference signals RS₁, RS₂, RS₃ and RS₄ surrounding the reference signal are r₁, r₂, r₃ and r₄, the reference signals RS₁ and RS₂ are arranged apart from the reference signal RS_{c} by 3 subcarriers and 4 symbols in frequency and time domain, respectively, the reference signals RS₃ and RS₄ are arranged apart from the reference signal RS_{c} by 3 subcarriers and 3 symbols in frequency and time domain, respectively, the predetermined weighting is r_{c}′=(3r₁+3r₂+4r₃+4r₄)/14 and a value obtained by multiplying a value of E(|r_{c}′−r_{c}|²) (E is an ensemble average) by 98/123 is an estimate value of interference power.

5. An interference power estimation method comprising:
a step of receiving a signal including a plurality of discontinuous reference signals on a time/frequency plane;
a step of extracting the reference signals from the signal;
a step of linear-combining the channel variation values obtained from reference signals surrounding a reference signal of a specific time/frequency on the time/frequency plane with predetermined weighting; and
a step of estimating interference power using a linear-combined value resulting from the linear combining.

6. The interference power estimation method according to claim 5, wherein an estimate value of interference power is obtained by calculating the square and average of a difference between the linear-combined value and a channel variation value calculated from the reference signal of a specific time/frequency.

7. The interference power estimation method according to claim 5, wherein the reference signals on the time/frequency plane are mapped to an arrangement in an LTE system.

8. The interference power estimation method according to claim 5, wherein it is assumed that a channel variation value calculated from reference signal RS_{c} of the specific time/frequency is r_{c}, channel variation values obtained from reference signals RS₁, RS₂, RS₃ and RS₄ surrounding the reference signal are r₁, r₂, r₃ and r₄, the reference signals RS₁ and RS₂ are arranged apart from the reference signal RS_{c} by 3 subcarriers and 4 symbols in frequency and time domain, respectively, the reference signals RS₃ and RS₄ are arranged apart from the reference signal RS_{c} by 3 subcarriers and 3 symbols in frequency and time domain, respectively, the predetermined weighting is r_{c}′=(3r₁+3r₂+4r₃+4r₄)/14 and a value obtained by multiplying a value of E(|r_{c}′−r_{c}|²) (E is an ensemble average) by 98/123 is an estimate value of interference power.
